(19) United States
(12) Patent Application Publication
(10) Pub. No.: US 2013/0189517 A1
(43) Pub. Date: Jul. 25, 2013

(54) MULTI-LAYER FLUORORESIN FILM, EXTRUSION METHOD THEREOF AND SOLAR MODULE USING THE SAME

(71) Applicants: HSIN YUAN CHEN, CHIAYI COUNTY (TW); HAO-JAN HSIAO, TAOYUAN COUNTY (TW)

(72) Inventors: HSIN YUAN CHEN, CHIAYI COUNTY (TW); HAO-JAN HSIAO, TAOYUAN COUNTY (TW)

(73) Assignee: ENTIRE TECHNOLOGY CO., LTD., TAOYUAN COUNTY (TW)

(21) Appl. No.: 13/457,573

(22) Filed: Apr. 27, 2012

(30) Foreign Application Priority Data
Jan. 20, 2012 (TW) 101102569

(51) Int. Cl. C09J 7/02; B32B 27/00

(52) U.S. Cl. 428/354

(57) ABSTRACT

A multi-layer fluororesin film includes a substrate layer having substantially parallel first and second surfaces, a first fluororesin layer formed on at least one of the first and second surfaces and a second fluororesin layer formed on the first fluororesin layer. The first fluororesin layer has a first fluorine polymer and a first adhesive polymer, and the ratio between the first fluorine polymer and the first adhesive polymer ranges from 0.05 to 0.9. The second fluororesin layer has a second fluorine polymer and a second adhesive polymer, and the ratio between the second fluorine polymer and the second adhesive polymer ranges from 1.2 to 19.

### BACKGROUND OF THE INVENTION

1. Field of the Invention

The present invention relates to a multi-layer fluororesin film. In particular, the present invention relates to a multi-layer fluororesin film applied to a solar module.

2. Description of Related Art

Green energy is defined to be the energy with lower environmental pollution. The technology in the production of the green energy has been widely researched. Solar energy is a relatively viable form of green energy, and has been highly researched/developed. For improving the efficiency of the solar energy, the solar module is usually installed in outdoor environment where sunlight can be directly harnessed. However, the outdoor hazards such as water (moisture) penetration and high temperature have been a long-standing problem in the industry. Usually, the backside of the solar cell is covered by a back sheet for repelling against the water. In other words, the weathering resistance and the lower water penetration of the back sheet are two important requirements for a solar module.

In the structure of the solar module, the top and the bottom sides of the solar cells are often covered by thermoplastic polymers, such as ethylene-vinyl acetate (EVA) and the thermoplastic polymers are also filled into the gaps between the solar cells. The back side of the solar module is covered by the back sheet having properties of weathering resistance and thermal resistance and the back sheet is made of plastic films by coating or adhesion methods. Due the weathering resistance of the fluororesin material, the fluororesin material is widely applied to the back sheet. However, the fluororesin film does not have enough adhesion property so that the layer-to-layer peeling issue may occur. In addition, the back sheet made of the fluororesin film may separate from the EVA film so as to decrease the reliability of the final product.

As shown in FIG. 1, the coating layers B1, C1 are co-extruded to form on the substrate A1. In the condition that B1, C1 have higher component ratio of fluororesin materials, the product may have better weathering resistance. However, the layer-to-layer peeling strength is low. In the condition that B1, C1 have higher composition of adhesive material, the combination strength can meet the requirement. However, the weathering resistance is decreased. Alternatively, as the adhesion method shown in FIG. 2, the top and the bottom surfaces of the substrate A2 are through a surface treatment (ST) and then the fluororesin films B2, C2 are adhered on the top and the bottom surfaces of the substrate A2. However, the layer-to-layer peeling strength is low when the films B2, C2 are attached onto the substrate A2. If another EVA film replaces the fluororesin films B2, C2 as the back sheet, the adhesive strength between the back sheet and the packaging film is improved. On the contrary, the back sheet of the EVA film may not provide enough weathering resistance. Accordingly, it is necessary to improve the quality and the manufacturing yield of the traditional methods.

### SUMMARY OF THE INVENTION

One object of the instant disclosure is providing a multi-layer fluororesin film which is formed by a co-extrusion process. By adjusting the component amounts of each layer, the co-extruded film has properties of high adhesion strength and high functional properties.

The instant disclosure provides a multi-layer fluororesin film comprising a substrate, a first fluororesin layer and a second fluororesin layer. The substrate has a first surface and a second surface, and the first surface and the second surface are substantially parallel to each other. The first fluororesin layer is formed on at least one of the first and the second surfaces. The first fluororesin layer comprises a first fluororesin material and a first adhesive material and the weight ratio of the first fluororesin material related to the first adhesive material ranges from 0.05 to 0.9. The second fluororesin layer is formed on the first fluororesin layer. The second fluororesin layer comprises a second fluororesin material and a second adhesive material, and the weight ratio of the second fluororesin material related to the second adhesive material ranges from 1.2 to 19.

The instant disclosure provides a multi-layer fluororesin film comprising a substrate, a first fluororesin layer, a second fluororesin layer and a third fluororesin layer. The first fluororesin layer comprises a first fluororesin material and a first adhesive material. The first fluororesin layer includes from about 5 to 30 weight percent of the first fluororesin material and from about 70 to 95 weight percent of the first adhesive material. The second fluororesin layer comprises a second fluororesin material and a second adhesive material. The second fluororesin layer includes from about 40 to 60 weight percent of the second fluororesin material and from about 60 to 40 weight percent of the second adhesive material. On the other hand, the third fluororesin layer includes from about 70 to 95 weight percent of the third fluororesin material and from about 5 to 30 weight percent of the third adhesive material.

The instant disclosure provides a co-extrusion method of the multi-layer fluororesin film. Step 1 is providing a substrate which has substantially parallel first and second surfaces. Step 2 is providing a first and at least one second extrusion apparatuses and at least one wheel set. The substrate is co-extruded by the first extrusion apparatus. The first fluororesin layer and the second fluororesin layer are co-extruded through the second extrusion apparatus and disposed on the first surfaces and/or the second surface. The second fluororesin layer is formed on the first fluororesin layer. The first fluororesin layer comprises a first fluororesin material and a first adhesive material and the weight ratio of the first fluororesin material related to the first adhesive material ranges from 0.05 to 0.9. The second fluororesin layer is formed on the first fluororesin layer. The second fluororesin layer comprises a second fluororesin material and a second adhesive material, and the weight ratio of the second fluororesin material related to the second adhesive material ranges from 1.2 to 19. Then, the wheel set is applied for cooling the substrate, the first fluororesin layer and the second fluororesin layer to form the present multi-layer fluororesin film.

The instant disclosure provides a solar module including a plurality of solar cells, at least one packaging element, and a multi-layer fluororesin film. Each packaging element has two opposite surfaces. The multi-layer fluororesin film comprises a substrate, a first fluororesin layer, and a second fluororesin layer. The substrate has a first surface and a second surface, and the first surface and the second surface are substantially parallel to each other. The first fluororesin layer is formed on at least one of the first and the second surfaces. The first fluororesin layer comprises a first fluororesin material (F1) and a first adhesive material (A1) with the weight ratio there-between ranges from 0.05 to 0.9. The second fluororesin layer is formed on the first fluororesin layer. The second fluororesin layer comprises a second fluororesin material (F2) and a second adhesive material (A2), and the weight ratio there-between ranges from 1.2 to 19. One surface of the packaging element carries the solar cells and the other surface is covered by the multi-layer fluororesin film.

The advantage of the present invention is that by adjusting the ratio of the fluororesin material and the adhesive material, the multi-layer fluororesin film may have properties of high adhesion strength and high functional properties, which is trade-off to each other. On the other hand, by using the co-extrusion method, the manufacturing yield of the polymer is improved and the manufacturing cost is reduced.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

FIG. 1 shows the co-extrusion method of the traditional film.

FIG. 2 shows the adhesion method of the traditional film.

FIG. 3 shows a multi-layer fluororesin film of the first embodiment of the present disclosure.

FIG. 4 shows the co-extrusion method of the multi-layer fluororesin film of the first embodiment of the present disclosure.

FIG. 5 shows a multi-layer fluororesin film of the second embodiment of the present disclosure.

FIG. 6 shows the co-extrusion method of the multi-layer fluororesin film of the first embodiment of the present disclosure.

FIG. 7 shows the solar module of the present disclosure.

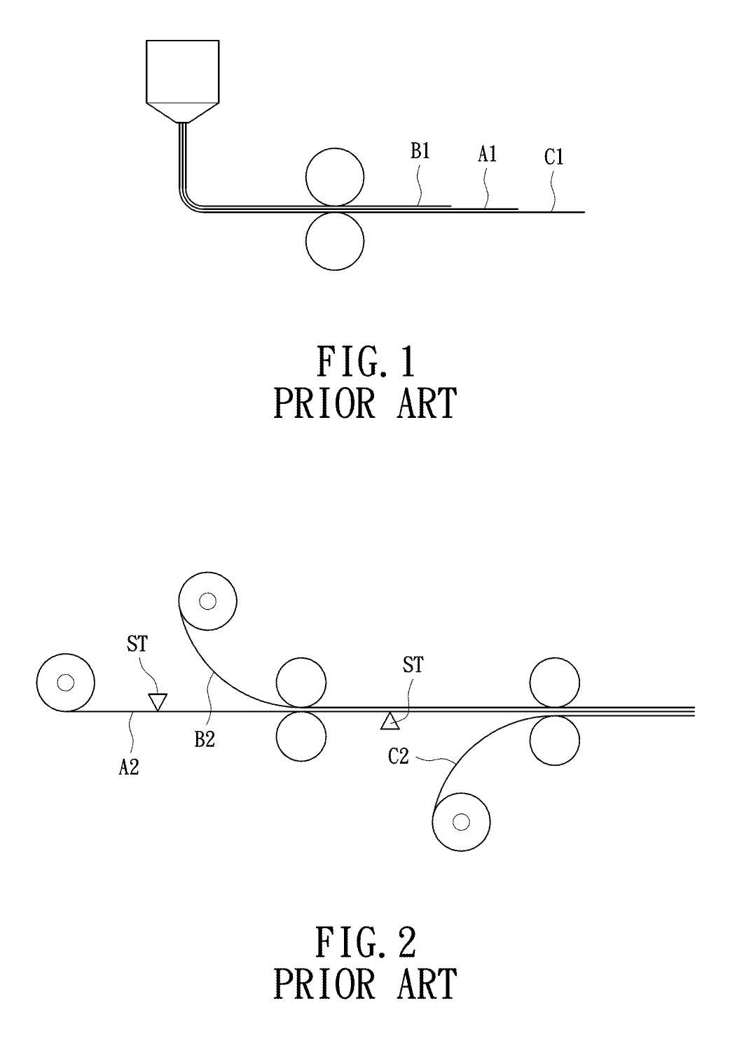

### DETAILED DESCRIPTION OF THE PREFERRED EMBODIMENTS

The instant disclosure provides a multi-layer fluororesin film which is formed by a co-extrusion process and the co-extruded multi-layer fluororesin film has properties of high adhesion strength and high protective characteristics, such as moisture-proof characteristic and weatherability (i.e., weathering resistance). The present multi-layer fluororesin film may be applied to a solar cell module; for example, the multi-layer fluororesin film is performed as a self-adhesive film attached on the solar cell module. Thus, the cell-side of the solar cell module can be firmly adhered to an external surface and the air-side of the solar cell module can have high functional properties, such as moisture-proof characteristic, corrosion resistance and so on.

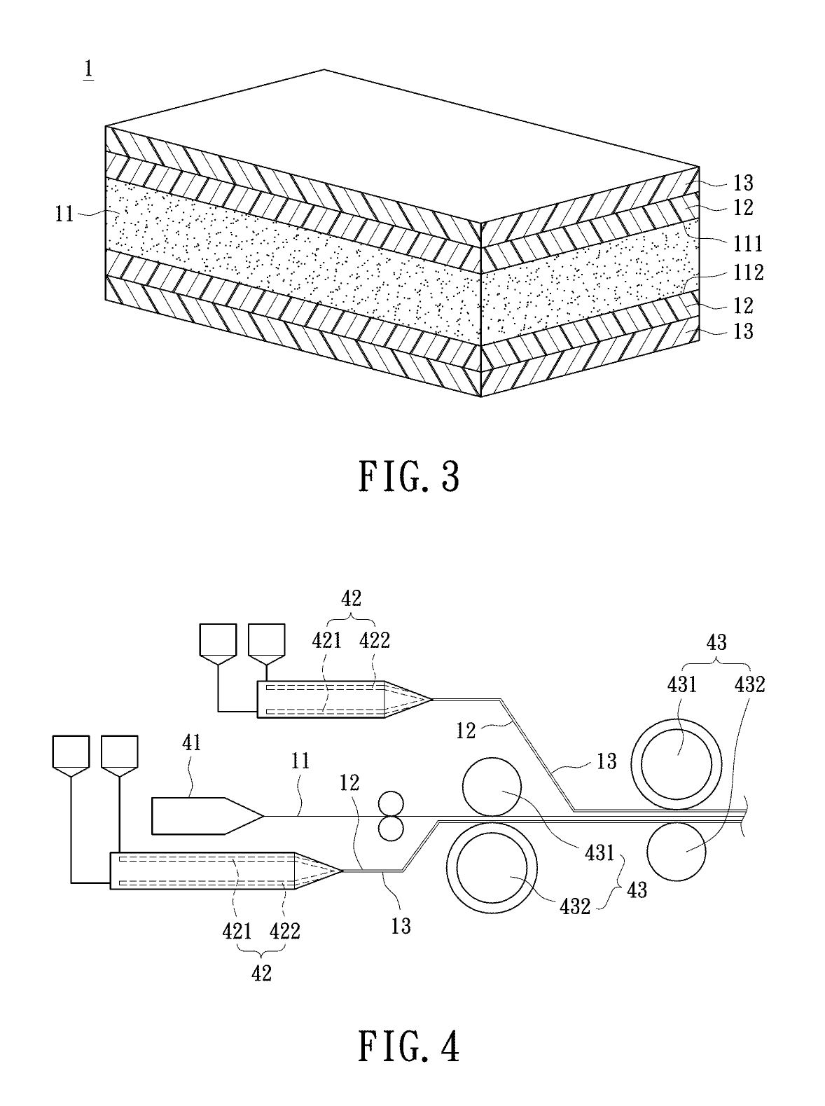

The present multi-layer fluororesin film includes at least a substrate, a first fluororesin layer and a second fluororesin layer disposed on the first fluororesin layer. The first and second fluororesin layers are formed on at least one surface of the substrate. Both of the first and second fluororesin layers have fluororesin materials (e.g., fluorine-contained materials) mixed with adhesive materials, additives, facilitating agent and so on. Please refer to FIG. 3; an illustrated multi-layer fluororesin film 1 of the first exemplary embodiment of the present disclosure is shown. The substrate 11 has opposite and substantially parallel first surface 111 and second surface 112. The first fluororesin layer 12 and the second fluororesin layer 13 are formed and stacked on both of the first surface 111 and the second surface 112. In detail, the first fluororesin layer 12 has a first fluororesin material (F1) and a first adhesive material (A1), and the weight ratio of the first fluororesin material related to the first adhesive material (e.g., F1/A1) ranges from 0.05 to 0.9. On the other hand, the second fluororesin layer 13 has a second fluororesin material (F2) and a second adhesive material (A2), and the weight ratio of the second fluororesin material related to the second adhesive material (e.g., F2/A2) ranges from 1.2 to 19.

In the exemplary embodiment, the substrate 11 may be polyethylene terephthalate (PET), polycarbonate (PC), tri-acetyl cellulose (TAC), polymethylmethacrylate (PMMA), methylmethacrylate styrene, cyclic olefin copolymer (COC), acrylonitrile butadiene styrene (ABS), polyolefine, polyester or styrene-acrylonitrile (SAN).

The first fluororesin material (F1) and the second fluororesin material (F2) may be, but not restricted, a fluororesin, e.g., fluoropolymer, such as polytetrafluoroethylene (PTFE), polyvinylidene fluride (PVDF), ethylene tetrafluoro ethylene copolymer (ETFE), polychlorotrifluoro ethylene (PCTFE), fluorinated ethylene propylene copolymer (FEP), tetrafluoro ethylene-perfluoroalkyl copolymer (PFA) or polyvinylfluoride (PVF). On the other hand, the first fluororesin material (F1) and the second fluororesin material (F2) also may be, but not restricted, a fluorinated comonomer, such as tetrafluoroethylene (TFE), hexafluoropropylene (HFP), perfluoro(2,2-dimethyl-1,3-dioxole) (PDD), chlorotrifluoroethylene (CTFE), perfluoropropyl vinylether (PPVE), perfluoromethyl vinyl ether (PMVE), or copolymer of pentafluoroethyl trifluorovinyl ether (PEVE) and per-fluoro-2-methylene-4-methyl-1,3-dioxolane (PMD).

The first adhesive material (A1) and the second adhesive material (A2) are respectively mixed with the first fluororesin material (F1) and the second fluororesin material (F2) to improve the adhesion strength provided by the first fluororesin layer 12 and the second fluororesin layer 13. The first adhesive material (A1) and the second adhesive material (A2) may be, but not limited thereby, carboxyl functional resin, chlorine-contained polyester resin, chlorine-contained polyolefin, polyamide resin, amino functional resin, amino silane coupling agent, hydrocyanic ester resin, nitric ester resin and phosphoric ester resin. In detail, the carboxyl functional resin may be resins having or substituted by RCOOH group or Cl-RCOOR′ group. The polyamide resin may be resins having or substituted by RCONR₂ group or imide group. The amino functional resin may be resins having or substituted by amino group, such as RNH₂, R₂NH, R₃N, or imino group, such as RC(═NH)R′, RC(═NR)R′, RC(═NH)H, RC(═NR')H. The hydrocyanic ester resin may be resins having or substituted by cyanate ester group, such as ROCN, RNC, or RNCO group, or RNCS group. The nitric ester resin may be resins having or substituted by RONO₂ group, RONO group, RNO₂ group or RNO group. The phosphoric ester resin may be resins having or substituted by HO(PO)(OR)₂ group, R(PO)(OH)₂ group, or RO(PO)(OH)₂ group. Preferably, the first adhesive material (A1) and the second adhesive material (A2) are amino functional resin; more preferably, the first adhesive material (A1) and the second adhesive material (A2) are amino-contained acrylic acid polymer.

In addition, the first fluororesin layer 12 and the second fluororesin layer 13 further have fillers mixed inside to improve the film properties, such as moisture-proof characteristic, gas-proof characteristic, corrosion resistance and weatherability. For example, the mixed filler may be CaCO₃ or BaSO₄. Moreover, the fillers may be added into the first fluororesin layer 12 and the second fluororesin layer 13 to improve the optical properties thereof. For example, the mixed filler may be TiO₂, SiO₂, Al₂O₃, ZnO and so on so that the first fluororesin layer 12 and the second fluororesin layer 13 have white color and then have high reflection rate.

Moreover, the first fluororesin layer 12 and the second fluororesin layer 13 of the first exemplary embodiment have additives and facilitating agents. The additives and facilitating agents may improve the compatibility between the fluororesin materials and the adhesive materials. For example, the additives may be coloring agents, UV absorbing agents, antioxidants or hindered amine light stabilizers (HALS).

In detail, the first fluororesin layer 12 includes from about 5 to 45 weight percent (wt %) of the first fluororesin material (F1) and from about 55 to 95 weight percent of the first adhesive material (A1). The second fluororesin layer 13 includes from about 55 to 95 weight percent of the second fluororesin material (F2) and from about 5 to 45 weight percent of the second adhesive material (A2). In other words, the first fluororesin layer 12 which is closed to the substrate 11 has more composition of adhesive material (A1) than the composition of fluororesin material (F1) so as to increase the adhesion strength between the substrate 11 and the second fluororesin layer 13. The outer second fluororesin layer 13 has more composition of fluororesin material (F2) than the composition of adhesive material (A2) so as to improve the functional properties of the present multi-layer fluororesin film 1.

Regarding the first fluororesin layer 12, when the first fluororesin layer 12 has 5 weight percent of the first fluororesin material (F1), the first fluororesin layer 12 has 95 weight percent of the first adhesive material (A1). In this condition, the weight ratio (F1/A1) of the first fluororesin material (F1) related to the first adhesive material (A1) is calculated as about 0.053. When the first fluororesin layer 12 has 45 weight percent of the first fluororesin material (F1), the first fluororesin layer 12 has 55 weight percent of the first adhesive material (A1). In this condition, the weight ratio (F1/A1) of the first fluororesin material (F1) related to the first adhesive material (A1) is calculated as about 0.8. Thus, the requirement of the weight ratio (F1/A1) ranges from 0.05 to 0.9 may be substantially met. Regarding the second fluororesin layer 13, when the second fluororesin layer 13 has 55 weight percent of the second fluororesin material (F2), the second fluororesin layer 13 has 45 weight percent of the second adhesive material (A2). In this condition, the weight ratio (F2/A2) of the second fluororesin material (F2) related to the second adhesive material (A2) is calculated as about 1.2. When the second fluororesin layer 13 has 95 weight percent of the second fluororesin material (F2), the second fluororesin layer 13 has 5 weight percent of the second adhesive material (A2). In this condition, the weight ratio (F2/A2) of the second fluororesin material (F2) related to the second adhesive material (A2) is calculated as about 19. Thus, the requirement of the weight ratio (F2/A2) ranges from 1.2 to 19 may be substantially met.

On the other hand, the weight ratio (F2/F1) of the second fluororesin material (F2) related to the first fluororesin material (F1) is discussed hereinafter. When the first fluororesin layer 12 has 5 weight percent of the first fluororesin material (F1) and the second fluororesin layer 13 has 95 weight percent of the second fluororesin material (F2), the weight ratio (F2/F1) is calculated as about 19, assuming the first and the second fluororesin layers 12, 13 have equal weight. When the first fluororesin layer 12 has 45 weight percent of the first fluororesin material (F1) and the second fluororesin layer 13 has 55 weight percent of the second fluororesin material (F2), the weight ratio (F2/F1) is calculated as about 1.2. In other words, the weight ratio (F2/F1) ranges from 1.2 to 19.

The weight ratio (A2/A1) of the second adhesive material (A2) related to the first adhesive material (A1) is discussed hereinafter. When the first fluororesin layer 12 has 55 weight percent of the first adhesive material (A1) and the second fluororesin layer 13 has 45 weight percent of the second adhesive material (A2), the weight ratio (A2/A1) is calculated as about 0.81. When the first fluororesin layer 12 has 95 weight percent of the first adhesive material (A1) and the second fluororesin layer 13 has 5 weight percent of the second adhesive material (A2), the weight ratio (A2/A1) is calculated as about 0.053. In other words, the weight ratio (A2/A1) ranges from about 0.05 to about 0.9.

Please refer to FIG. 4; the manufacturing apparatus for forming the multi-layer fluororesin film 1 of the first exemplary embodiment is shown and the manufacturing method may include the following steps:

Step 1 is providing a substrate 11, which has substantially parallel first and second surfaces 111, 112. As shown in FIG. 4, the substrate 11 may be continuously supplied by a first extrusion apparatus 41 and the material of the substrate 11 is discussed in the foregoing description.

Step 2 is providing first and second extrusion apparatuses 41, 42 and a wheel set 43. The substrate 11 is formed through the first extrusion apparatus 41 by an extrusion method. On the other hand, the first fluororesin layer 12 and the second fluororesin layer 13 are formed through the second extrusion apparatus 42 by a co-extrusion method and disposed on the first surfaces 111 and/or the second surface 112. As shown in FIG. 4, two second extrusion apparatuses 42 are provided to form the first fluororesin layer 12 and the second fluororesin layer 13 on the first surfaces 111 and the second surface 112. Taking an example of the first fluororesin layer 12, the material is subjected and fed to the second extrusion apparatus 42, and the first fluororesin material (F1) and the first adhesive material (A1) are extruded through the first and the second extrusion outlets 421, 422. More specifically, the material is extruded through a die of die lip of 0.05 to 0.5 mm using an extruder having a screw with L/D ratio=20 to 50 at a line speed of about 10 to 100 m/min, in an air gap of about 2 to 500 mm. Then, the extruded materials (i.e., the first fluororesin layer 12 and the second fluororesin layer 13) are co-extruded on the substrate 11. On the other hand, the materials of the first fluororesin layer 12 and the second fluororesin layer 13 are discussed in the foregoing description. Furthermore, an upper cooling wheel 431 and a bottom cooling wheel 432 of the wheel set 43 are applied for cooling the substrate 11, the first fluororesin layer 12 and the second fluororesin layer 13, and then the present multi-layer fluororesin film 1 is formed.

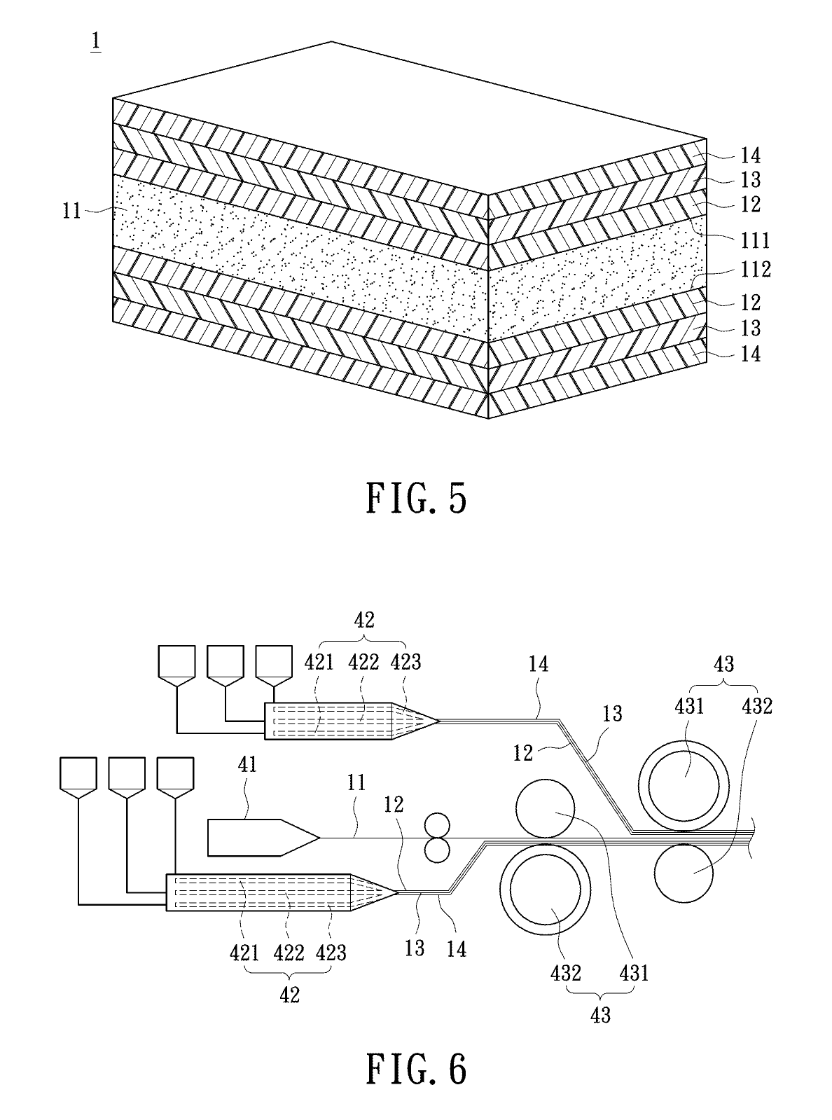

Please refer to FIG. 5; the multi-layer fluororesin film 1 of the second exemplary embodiment is shown. The difference between the first and the second multi-layer fluororesin films 1 is that the multi-layer fluororesin film 1 of the second exemplary embodiment has three fluororesin layers, i.e., the first fluororesin layer 12, the second fluororesin layer 13 and the third fluororesin layer 14 on the substrate 11. Similarly, the first fluororesin layer 12 has a first fluororesin material (F1) and a first adhesive material (A1), the second fluororesin layer 13 has a second fluororesin material (F2) and a second adhesive material (A2), and the third fluororesin layer 14 has a third fluororesin material (F3) and a third adhesive material (A3). The weight ratio (F1/A1) ranges from about 0.05 to 0.9; preferably, the weight ratio (F1/A1) ranges from about 0.05 to 0.5. The weight ratio (F2/A2) ranges from about 1.2 to 19; preferably, the weight ratio (F2/A2) ranges from about 0.6 to 1.5. On the other hand, the weight ratio (F3/A3) of the third fluororesin material (F3) and the third adhesive material (A3) ranges from about 2 to 19.

The detail composition of the multi-layer fluororesin film 1 of the second exemplary embodiment is disclosed hereinafter. The first fluororesin layer 12 includes from about 5 to 30 weight percent (wt %) of the first fluororesin material (F1) and from about 70 to 95 weight percent of the first adhesive material (A1). The second fluororesin layer 13 includes from about 40 to 60 weight percent of the second fluororesin material (F2) and from about 60 to 40 weight percent of the second adhesive material (A2). On the other hand, the third fluororesin layer 14 includes from about 70 to 95 weight percent of the third fluororesin material (F3) and from about 5 to 30 weight percent of the third adhesive material (A3).

When the first fluororesin layer 12 has 5 weight percent of the first fluororesin material (F1) and the first fluororesin layer 12 has 95 weight percent of the first adhesive material (A1), the weight ratio (F1/A1) is calculated as about 0.053. When the first fluororesin layer 12 has about 30 weight percent of the first fluororesin material (F1) and about 70 weight percent of the first adhesive material (A1), the weight ratio (F1/A1) is calculated as about 0.42. Thus, the requirement of the weight ratio (F1/A1) ranges from 0.05 to 0.5 may be substantially met. Regarding the second fluororesin layer 13, when the second fluororesin layer 13 has 40 weight percent of the second fluororesin material (F2) and 60 weight percent of the second adhesive material (A2), the weight ratio (F2/A2) is calculated as about 0.66. When the second fluororesin layer 13 has 60 weight percent of the second fluororesin material (F2) and 40 weight percent of the second adhesive material (A2), the weight ratio (F2/A2) is calculated as about 1.5. Thus, the requirement of the weight ratio (F2/A2) ranges from 0.6 to 1.5 may be substantially met. Regarding the third fluororesin layer 14, when the third fluororesin layer 14 has 70 weight percent of the third fluororesin material (F3) and 30 weight percent of the third adhesive material (A3), the weight ratio (F3/A3) is calculated as about 2.33. When the third fluororesin layer 14 has 95 weight percent of the third fluororesin material (F3) and 5 weight percent of the third adhesive material (A3), the weight ratio (F3/A3) is calculated as about 19. Thus, the requirement of the weight ratio (F2/A2) ranges from 2 to 19 may be substantially met.

On the other hand, the weight ratios between the third fluororesin material (F3), the second fluororesin material (F2) and the first fluororesin material (F 1) are discussed hereinafter. When the first fluororesin layer 12 has 5 weight percent of the first fluororesin material (F1) and the second fluororesin layer 13 has 60 weight percent of the second fluororesin material (F2), the weight ratio (F2/F1) is calculated as about 12, assuming the first and the second fluororesin layers 12, 13 have equal weight. When the first fluororesin layer 12 has 30 weight percent of the first fluororesin material (F1) and the second fluororesin layer 13 has 40 weight percent of the second fluororesin material (F2), the weight ratio (F2/F1) is calculated as about 1.33. In other words, the weight ratio (F2/F1) ranges from 1.3 to 12.

When the second fluororesin layer 13 has 60 weight percent of the second fluororesin material (F2) and the third fluororesin layer 14 has 70 weight percent of the third fluororesin material (F3), the weight ratio (F3/F2) is calculated as about 1.16, assuming the second and the third fluororesin layers 13, 14 have equal weight. When the second fluororesin layer 13 has 40 weight percent of the second fluororesin material (F2) and the third fluororesin layer 14 has 95 weight percent of the third fluororesin material (F3), the weight ratio (F3/F2) is calculated as about 2.37. To sum up, weight ratio (F3/F2) ranges from about 1.1 to 2.4.

The weight ratios between the third adhesive material (A3), the second adhesive material (A2) and the first adhesive material (A1) are discussed hereinafter. When the first fluororesin layer 12 has 70 weight percent of the first adhesive material (A1) and the second fluororesin layer 13 has 60 weight percent of the second adhesive material (A2), the weight ratio (A2/A1) is calculated as about 0.85. When the first fluororesin layer 12 has 95 weight percent of the first adhesive material (A1) and the second fluororesin layer 13 has 40 weight percent of the second adhesive material (A2), the weight ratio (A2/A1) is calculated as about 0.42. To sum up, the weight ratio (A2/A1) ranges from about 0.4 to 0.9.

When the second fluororesin layer 13 has 40 weight percent of the first adhesive material (A2) and the third fluororesin layer 14 has 30 weight percent of the third adhesive material (A3), the weight ratio (A3/A2) is calculated as about 0.75. When the second fluororesin layer 13 has 60 weight percent of the first adhesive material (A2) and the third fluororesin layer 14 has 5 weight percent of the third adhesive material (A3), the weight ratio (A3/A2) is calculated as about 0.083. To sum up, the weight ratio (A3/A2) ranges from about 0.08 to about 0.75.

Please refer to FIG. 6; the manufacturing apparatus for forming the multi-layer fluororesin film 1 of the second exemplary embodiment is shown and the manufacturing method may include the following steps:

Step 1 is providing a substrate 11, which has substantially parallel first and second surfaces 111, 112. As shown in FIG. 6, the substrate 11 may be continuously supplied by a first extrusion apparatus 41 and the material of the substrate 11 is discussed in the foregoing description.

Step 2 is providing first and second extrusion apparatuses 41, 42 and a wheel set 43. The substrate 11 is formed through the first extrusion apparatus 41 by an extrusion method. On the other hand, the first fluororesin layer 12, the second fluororesin layer 13 and the third fluororesin layer 14 are formed through the second extrusion apparatus 42 by a co-extrusion method and disposed on the first surfaces 111 and/or the second surface 112. As shown in FIG. 6, two second extrusion apparatuses 42 are provided to form the first fluororesin layer 12, the second fluororesin layer 13 and the third fluororesin layer 14 on the first surfaces 111 and the second surface 112. On the other hand, the materials of the first fluororesin layer 12, the second fluororesin layer 13 and the third fluororesin layer 14 are discussed in the foregoing description. Due to the composition difference of the fluororesin material in the first fluororesin layer 12, the second fluororesin layer 13 and the third fluororesin layer 14, the extrusion condition may be different. For example, the materials may be fed through the extruder having high extrusion temperature for extruding the third fluororesin layer 14 with higher composition of fluororesin material. In an exemplary embodiment, the materials of first fluororesin material (F1) and the first adhesive material (A1) are extruded through the first extrusion outlet 421 of the second extrusion apparatus 42 at temperature about 170 to 230 degrees Celsius. The materials of second fluororesin material (F2) and the second adhesive material (A2) are extruded through the second extrusion outlet 422 of the second extrusion apparatus 42 at temperature about 210 to 260 degrees Celsius. The materials of third fluororesin material (F3) and the third adhesive material (A3) are extruded through the third extrusion outlet 423 of the second extrusion apparatus 42 at temperature about 240 to 290 degrees Celsius. Furthermore, the upper cooling wheel 431 and the bottom cooling wheel 432 of the wheel set 43 are applied for cooling the substrate 11, the first fluororesin layer 12, the second fluororesin layer 13 and the third fluororesin layer 14, and then the present multi-layer fluororesin film 1 is formed. In detail, the cooling temperature provided by the wheel set 43 is about 50 to 180 degrees Celsius for shaping the multi-layer fluororesin film 1.

In addition, the extrusion condition is that L/D ratio=20 to 50, line speed=10 to 100 m/min, die lip=0.05 to 0.5 mm and air gap=2 to 500 mm.

Some experimental results of preferable embodiments and comparative examples are shown and discussed hereinafter.

### Comparative Example 1

the fluororesin film which includes fluororesin in 100% by mass (i.e., the main component), fillers in 20% based on the mass of the main component and additives in 5% based on the mass of the main component, without adhesive material (e.g., zero part in mass) is attached onto the substrate.

### Comparative Example 2

the fluororesin film which includes the main component of fluororesin in 70 wt % and adhesive material in 30 wt %, and fillers in 20% based on the mass of the main component and additives in 5% based on the mass of the main component is coated onto the substrate.

### Comparative Example 3

the single fluororesin film which includes the main component of fluororesin in 70 wt % and adhesive material in 30 wt %, and fillers in 20% based on the mass of the main component and additives in 5% based on the mass of the main component is co-extruded onto the substrate.

### Comparative Example 4

the dual fluororesin layers that one includes the main component of fluororesin in 100 wt % and adhesive material in 0 wt %, and fillers in 20% based on the mass of the main component and additives in 5% based on the mass of the main component and the other includes the main component of fluororesin in 0 wt % and adhesive material in 100 wt %, and fillers in 20% based on the mass of the main component and additives in 5% based on the mass of the main component are co-extruded onto the substrate.

TABLE 1
shows the composition of the preferable examples:

| | first fluororesin | second fluororesin | third fluororesin |
|---|---|---|---|
| | layer | layer | layer |
| Ex. 1 | A: 40%, B: 60%, | A: 60%, B: 40%, | — |
| | C: 0%, D: 0% | C: 20%, D: 5% | |
| Ex. 2 | A: 20%, B: 80%, | A: 80%, B: 20%, | — |
| | C: 0%, D: 0% | C: 20%, D: 5% | |
| Ex. 3 | A: 30%, B: 70%, | A: 50%, B: 50%, | A: 70%, B: 30%, |
| | C: 0%, D: 0% | C: 0%, D: 0% | C: 20%, D: 5% |
| Ex. 4 | A: 10%, B: 90%, | A: 50%, B: 50%, | A: 90%, B: 10%, |
| | C: 0%, D: 0% | C: 0%, D: 0% | C: 20%, D: 5% |

Note:
A: fluororesin material
B: adhesive material
C: fillers
D: additives

According to Table. 1, the Ex. 1 and Ex. 2 are two-layer co-extrusion indicated by the above-mentioned first embodiment, and the Ex. 3 and Ex. 4 are three-layer co-extrusion indicated by the above-mentioned second embodiment.

The Comparative examples 1-4 (shown as S1-S4 in Table. 2) and the Ex. 1-4 (shown as E1-E4 in Table. 2) are applied in solar cells and then brought to some tests. Please note that the Comparative examples 1-4 are manufactured by traditional coating or attachment methods. The experimental results are shown in Table. 2.

TABLE 2

| | | | | | P* | | E* | |
|---|---|---|---|---|---|---|---|---|
| | | | | | Condition: | | Condition: | |
| | | | T* | W* | 85° C./ | | 85° C./ | |
| | | | 150° C., | 38° C./ | RH85% | | RH85% | |
| | AC* | SC* | 30 min | RH90% | 2000 hrs | | 2000 hrs | |
| S1 | □ | □ | 0.9% | 1.8 | <3 | <3 | <50 | <50 |
| S2 | ∘ | ∘ | 0.4% | 1.7 | N1* | N2* | 62 | 52 |
| S3 | ∘ | ∘ | 0.5% | 2.4 | 6.8 | 6.3 | 78 | 66 |
| S4 | □ | □ | 0.7% | 2.1 | <5 | <3 | <50 | <50 |
| E1 | ∘ | ∘ | 0.2% | 1.2 | 7 | 82 | 82 | 75 |
| E2 | □ | □ | 0.3% | 1.0 | 7.2 | 80 | 80 | 78 |
| E3 | ∘ | ∘ | 0.2% | 0.8 | 8.1 | 81 | 81 | 79 |
| E4 | □ | □ | 0.1% | 0.5 | 8.2 | 80 | 80 | 80 |

“T” means “thermal-shrinking ratio”
“W” means “water-proof test” and the target value less than 2 g/m² * day is required
“P” means “layer-to-layer peeling strength” and the target value larger than 4 N/cm is required
“E” means “EVA adhesion strength” and the target value larger than 50 N/cm is required
“AC” means the property of surface anti-corrosion
“SC” means the property of surface self-clean
□: better
∘: good
N1, N2: no peeling occurs and that means the adhesion strength is improved.

According to the results shown in Table.2, the film of Comparative example 1 which is formed by the attaching method has low layer-to-layer attachment strength (i.e., the peeling strength) and the combination strength between the film of Comparative example 1 and EVA film may not meet the requirement. Furthermore, the film of Comparative example 1 which is formed by the attaching method has high thermal-shrinking ratio so that the reliability and the stability of the final product is influenced.

The film of Comparative example 2 is formed by the coating method. When the formed film contains high composition of fluororesin, the film may provide high functional properties, such as weathering resistance. On the contrary, the layer-to-layer peeling strength is low. When the formed film contains high composition of adhesive material, the combination strength between the film of Comparative example 2 and EVA film can meet the requirement. On the contrary, the functional properties, such as weathering resistance are decreased. According to the results of Comparative example 2, the layer-to-layer peeling strength and the water-proof property simply meet the requirement, but the film properties are not outstanding.

The film of Comparative example 3 is formed by co-extruding a single film having a fluororesin material and an adhesive material on the substrate. When the formed film contains high composition of fluororesin material, the film may provide high functional properties, such as weathering resistance. On the contrary, the layer-to-layer peeling strength is low. When the formed film contains high composition of adhesive material, the combination strength between the film of Comparative example 2 and EVA film can meet the requirement. On the contrary, the functional properties, such as weathering resistance are decreased. According to the results of Comparative example 3, the layer-to-layer peeling strength simply meets the requirement but the water-proof property, e.g., the weathering resistance cannot meet the requirement.

The film of Comparative example 4 is formed by co-extruding a dual film having a 100% fluororesin layer and a 100% adhesive layer on the substrate. According to the results, the layer-to-layer peeling strength is low because that the low surface energy of the 100% fluororesin layer decreases the attachment strength provided by the adhesive layer.

According to the results of E1-E4, the present multi-layer fluororesin film 1 has high combination strength, which is indicated by the high strength of the layer-to-layer peeling strength and the high strength between the present film and the EVA film, and high weathering resistance, which is indicated by the high water-proof property. In other words, the traditional trade-off between the high combination strength and the functional properties is overcome by the present invention.

Moreover, the properties of the shrinkages of the present multi-layer fluororesin film 1 applied on a solar module in the machine direction (MD) and the transverse direction (TD) are shown in Table. 3 and Table. 4.

TABLE 3

| | Elongation (MD, %) | | |
|---|---|---|---|
| | double-side | double-side | present co- |
| □ | coating | attachment | extruded film |
| 25 | 0.000 | 0.000 | 0.000 |
| 50 | 0.000 | 0.000 | 0.000 |
| 100 | 0.000 | −0.084 | 0.000 |
| 150 | −0.083 | −0.669 | 0.000 |
| 200 | −0.095 | −3.117 | 0.000 |

Note:
humidity is less than 85 RH %

TABLE 4

| | Elongation (TD, %) | | |
|---|---|---|---|
| | double-side | double-side | present co- |
| □ | coating | attachment | extruded film |
| 25 | 0.000 | 0.000 | 0.000 |
| 50 | 0.000 | −0.083 | 0.000 |
| 100 | 0.084 | −0.084 | 0.000 |
| 150 | −0.083 | −0.445 | 0.000 |
| 200 | −0.083 | −2.912 | 0.000 |

Note:
humidity is less than 85 RH %

According to the experimental results, the present multi-layer fluororesin film 1 has high stability in the machine direction (MD) and the transverse direction (TD) at 25 to 200□. In other words, the present multi-layer fluororesin film 1 has low deformation resulted from the environment conditions. On the contrary, the traditional films formed by double-side coating or double-side attachment methods have greater deformation in high temperature environment.

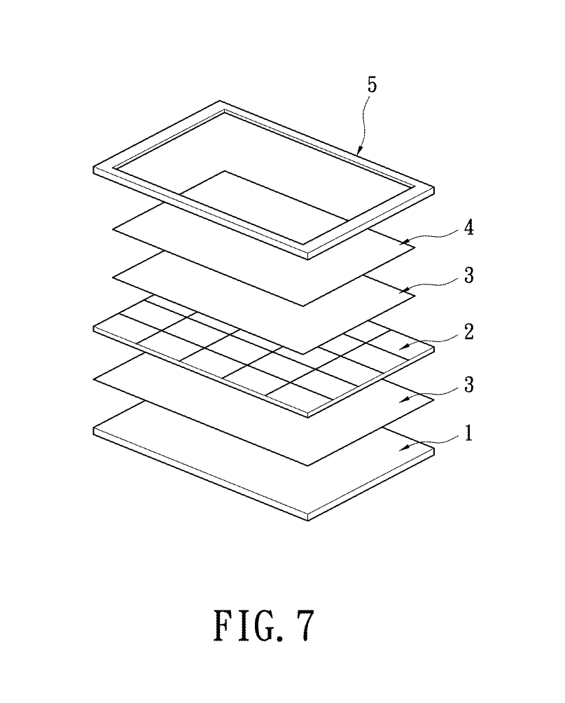

Please refer to FIG. 7; the instant disclosure further provides a solar module. The solar module at least includes a plurality of solar cells 2 and at least one packaging element 3. One side of the packaging element 3 is used to carry the solar cells 2 and the other side of the packaging element 3 has the multi-layer fluororesin film 1 to cover the solar cells 2 and the packaging element 3. In an exemplary embodiment, the packaging element 3 is made by ethylene-vinyl acetate (EVA) which has properties of high connection strength, UV resistance, insulating property and high water-proof property. The present multi-layer fluororesin film 1 has high connection strength with the packaging element 3 (i.e., the EVA film), which is indicated by the above tests of the layer-to-layer peeling strength and the adhesion strength therebetween. Furthermore, the present multi-layer fluororesin film 1 provides high functional properties, such as high weathering resistance, which is indicated by the water-proof test. On the other hand, the solar cells 2 are packaged between two packaging elements 3. One surface of the solar cells 2, on which the sun light beam is projected, is covered by a transparent material 4, such as a glass cover or a transparent plastic cover. Then, the multi-layer fluororesin film 1 and a frame 5, such as an aluminum frame are used to clamp and fix the solar cells 2, the packaging elements 3 and the transparent material 4.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. A multi-layer fluororesin film, comprising:
a substrate, having a first surface and a second surface, the first surface and the second surface being substantially parallel to each other;
a first fluororesin layer formed on at least one of the first and the second surfaces, wherein the first fluororesin layer comprises a first fluororesin material and a first adhesive material, the weight ratio of the first fluororesin material related to the first adhesive material ranges from 0.05 to 0.9; and
a second fluororesin layer formed on the first fluororesin layer, wherein the second fluororesin layer comprises a second fluororesin material and a second adhesive material, the weight ratio of the second fluororesin material related to the second adhesive material ranges from 1.2 to 19.

2. The multi-layer fluororesin film as claimed in claim 1, wherein the first fluororesin layer comprises from 5 to 45 weight percent of the first fluororesin material, the first fluororesin layer comprises from 55 to 95 weight percent of the first adhesive material, and the second fluororesin layer comprises from 5 to 45 weight percent of the second adhesive material.

3. The multi-layer fluororesin film as claimed in claim 1, wherein the weight ratio of the second fluororesin material related to the first fluororesin material ranges from 1.2 to 19.

4. The multi-layer fluororesin film as claimed in claim 3, wherein the first fluororesin layer comprises from 5 to 45 weight percent of the first fluororesin material, the first fluororesin layer comprises from 55 to 95 weight percent of the first adhesive material, and the second fluororesin layer comprises from 5 to 45 weight percent of the second adhesive material.

5. The multi-layer fluororesin film as claimed in claim 3, wherein the weight ratio of the second adhesive material related to the first adhesive material ranges from 0.05 to 0.9.

6. The multi-layer fluororesin film as claimed in claim 5, wherein the first fluororesin layer comprises from 5 to 45 weight percent of the first fluororesin material, the first fluororesin layer comprises from 55 to 95 weight percent of the first adhesive material, the second fluororesin layer comprises from 55 to 95 weight percent of the second fluororesin material, and the second fluororesin layer comprises from 5 to 45 weight percent of the second adhesive material.

7. The multi-layer fluororesin film as claimed in claim 1, further comprising a third fluororesin layer formed on the second fluororesin layer, wherein the third fluororesin layer comprises a third fluororesin material and a third adhesive material, the weight ratio of the third fluororesin material related to the third adhesive material ranges from 2 to 19.

8. The multi-layer fluororesin film as claimed in claim 7, wherein the weight ratio of the first fluororesin material related to the first adhesive material ranges from 0.05 to 0.5, and the weight ratio of the second fluororesin material related to the second adhesive material ranges from 0.6 to 1.5.

9. The multi-layer fluororesin film as claimed in claim 7, wherein the weight ratio of the third fluororesin material related to the second fluororesin material ranges from 1.1 to 2.4, and the weight ratio of the second fluororesin material related to the first fluororesin material ranges from 1.3 to 12.

10. The multi-layer fluororesin film as claimed in claim 9, wherein the weight ratio of the third adhesive material related to the second adhesive material ranges from 0.08 to 0.75, and the weight ratio of the second adhesive material related to the first adhesive material ranges from 0.4 to 0.9.
